(19) United States
(12) Patent Application Publication
(10) Pub. No.: US 2026/0233338 A1
(43) Pub. Date: Aug. 13, 2026

(54) TECHNIQUES FOR AUTOMATED MARKING OF DENTAL APPLIANCES

(71) Applicants: Miguel Guerrero, Austin, TX (US); Institut Straumann AG, Basel (CH)

(72) Inventor: Miguel Guerrero, Austin, TX (US)

(73) Assignee: Institut Straumann AG, Basel (CH)

(21) Appl. No.: 19/469,451

(22) PCT Filed: Mar. 28, 2024
(86) PCT No.: PCT/IB2024/053049

§ 371 Date: Sep. 26, 2025

(51) Int. Cl. B23K 26/362; A61C 7/00; A61C 7/08; B41J 2/44; B41J 3/407; B41J 3/44; B41J 11/00; B41J 13/08; B41J 29/12; B41J 29/377; B41M 5/00

(52) U.S. Cl. CPC B23K 26/362; A61C 7/002; A61C 7/08; B41J 2/442; B41J 3/4073; B41J 3/44; B41J 11/009; B41J 13/08; B41J 29/12; B41J 29/377; B41M 5/0082

(57) ABSTRACT

The present disclosure discusses techniques for marking a dental appliance. A dental model and dental appliance are positioned onto a conveyor tray, which is transported to a scan station. The dental model and conveyor tray each include an identifying code. The scan station includes a camera and barcode reader to read the identifying codes on the dental model and conveyor tray, and these codes are associated with one another. The conveyor tray then moves to a marking station where a barcode reader reads the code on the conveyor tray, and then marks the dental appliance with the appropriate marking.

### CROSS-REFERENCE TO RELATED APPLICATIONS

This application claims priority to and the benefit of U.S. Provisional Patent Application Ser. No. 63/456,072, entitled “Techniques for Automated Markings of Dental Appliances” filed on Mar. 31, 2023, the content of which are hereby incorporated by reference in its entirety.

### FIELD OF THE TECHNOLOGY

The present technology relates to dental appliance manufacturing techniques. More specifically, this technology relates to techniques for automated marking of dental appliances.

### BACKGROUND

Orthodontic aligners are appliances intended to make a series of discrete tooth position corrections aimed at aligning the teeth correctly. Aligners have many advantages over traditional bracket/wire braces for orthodontic treatment. For example, aligners are often transparent or semi-transparent, more comfortable than wire braces, and are removable for cleaning and for eating. The manufacture of aligners traditionally begins with generating a digital model of the patient's teeth, either by scanning the patient's teeth, or by making a dental impression of the patient's teeth and then scanning the impression. Once a digital model of the patient's teeth has been acquired, physical dental models can be fabricated (e.g. using 3D printing techniques) to provide a positive model of the teeth.

When an intra-oral scanning device (IOS device) is used to scan a patient's teeth, three-dimensional computer aided design (CAD) representations can be imported by custom software. The custom software allows the operator, such as a dental technician or dentist, to move individual teeth in specific and discrete movements and in a number of stages according to a treatment plan to achieve the final dental arch of aligned teeth.

For each stage of a patient's treatment plan, a 3D printed model of the dental arch is fabricated. This model can be washed and allowed to dry. Once dried, a polymer sheet can be thermoformed over the top of the 3D printed arch model to form the clear aligner.

The thermoformed part is then marked with part identification. The marked and thermoformed part is then cut by one of several methods so that the aligner that goes to the customer can be separated from the excess aligner material.

The aligner is then polished to remove burrs and sharp edges, inspected, and then packaged to be shipped to the patient's orthodontist, or directly to the patient.

### SUMMARY

The present technology relates to marking orthodontic appliances, such as transparent or semitransparent aligners, dental splints, retainers, etc. These orthodontic appliances can be made of a polymer material, and can be manufactured using a thermoforming or direct manufacturing (3D printing or other additive manufacturing) process, in some embodiments. Some advantages of the present disclosure include the ability to automatically mark multiple appliances at the same time, and the ability to expand or scale an automated marking system to include more or fewer laser marking stations.

In one embodiment, the present technology relates to a method of marking a dental appliance. The method includes: positioning a dental model and a dental appliance on a conveyor tray, and moving the conveyor tray to a scan station. The dental model includes a first code corresponding to a part number associated with the dental appliance, and the conveyor tray includes a second code specific to the conveyor tray. The scan station includes a camera for reading the first code, and a first barcode reader for reading the second code. The method also includes reading the first code using the camera associated with a computing system to identify the part number associated with the dental appliance. The method also includes reading the second code using the first barcode reader to identify the conveyor tray. The method also includes associating the first code corresponding to the part number with the second code corresponding to the conveyor tray, and moving the conveyor tray to a marking station. The marking station includes a laser source and a second barcode reader. The method also includes reading the second code using the second barcode reader to identify the part number based on the association between the first code and the second code, and marking the dental appliance using the laser source.

In some embodiments, the dental appliance is a transparent aligner thermoformed over the dental model. In some embodiments, associating the first code with the second code allows the conveyor tray to be sent to any one of a number of laser marking stations. In some embodiments, moving the conveyor tray to the marking station includes moving the conveyor tray to any one of the laser marking stations. In some embodiments, the marking station is shielded using one or more opaque barriers and one or more transparent laser shielding panes. In some embodiments, the dental appliance is positioned on the conveyor tray at a loading station. In some embodiments, moving the conveyor tray includes transporting the conveyor tray along a linear conveyor system or conveyor belt. In some embodiments, moving the conveyor tray includes transporting the conveyor tray in two dimensions over a surface of a magnetized table conveyor system. In some embodiments, the first code is a serial number printed into a portion of the dental model during a 3D printing process. In some embodiments, the first barcode reader and the second barcode reader can read a two-dimensional barcode or a three-dimensional barcode.

In another embodiment, the present technology relates to a system for marking an orthodontic aligner. The system includes a loading station, a scan station, a marking station, a computing system, and a conveyor system. The loading station includes a conveyor tray for holding a dental model and a dental appliance. The dental model includes a first code corresponding to a part number associated with the dental appliance, and the conveyor tray includes a second code specific to the conveyor tray. The scan station includes a camera for reading the first code, and a first barcode reader for reading the second code. The marking station includes a laser source and a second barcode reader. The computing system is in communication with the camera, the first barcode reader, the second barcode reader, and the laser source. The computing system is configured to associate the first code corresponding to the part number with the second code corresponding to the conveyor tray; identify the part number at the marking station using information obtained from the second barcode reader; and instruct the laser source to mark the dental appliance with the appropriate marking, The conveyor system moves the conveyor tray between the loading station, the scan station, and the marking station.

In some embodiments, the marking station also includes a fume extractor to expel any fumes or debris generated during the laser marking process. In some embodiments, the dental appliance is a transparent aligner thermoformed over the dental model. In some embodiments, associating the first code with the second code allows the conveyor tray to be sent to any one of a number of laser marking stations. In some embodiments, moving the conveyor tray to the marking station includes moving the conveyor tray to any one of the laser marking stations. In some embodiments, the system also includes one or more opaque barriers and one or more transparent laser shielding panes for shielding the marking stations. In some embodiments, the conveyor system includes a linear conveyor system or conveyor belt, In some embodiments, the conveyor system includes a magnetized table conveyor system. In some embodiments, the first barcode reader and the second barcode reader can read a two-dimensional barcode or a three-dimensional barcode.

In another embodiment, the present disclosure relates to an automated laser marking system, including a loading station, a scan station, a number of marking stations, a conveyor system, and a computing system. The loading station is for loading a number of conveyor trays, each having a 3D printed dental model and a dental appliance. Each dental model includes a first code corresponding to a part number associated with the dental appliance, and each conveyor tray includes a second code specific to the conveyor tray. Each dental appliance is thermoformed over a dental model and loaded onto a conveyor tray. The scan station includes a camera for reading the first code, and a first barcode reader for reading the second code. Each marking station includes a laser source, a second barcode reader, and a fume extractor. The conveyor system moves each of the conveyor trays between the loading station, the scan station, and one of the marking stations. The computing system is in communication with the camera, the first barcode reader, the second barcode reader, and the laser source, The computing system is configured to associate the first code corresponding to the part number with the second code corresponding to the conveyor tray for each of the conveyor trays at the scan station. For each conveyor tray located at each of the plurality of marking stations, the computing system is configured to identify the part number at the marking station using information obtained from the second barcode reader. For each of the marking stations, the computing system is configured to instruct the laser source to mark the dental appliance with the appropriate marking.

### BRIEF DESCRIPTION OF THE DRAWINGS

The technology will be more fully understood from the following detailed description taken in conjunction with the accompanying drawings, in which:

FIG. 1 shows an example automated laser marking system, according to an embodiment of the present disclosure.

FIG. 2 illustrates an example 3D printed dental model 201 with transparent aligner material 203 thermoformed over it, according to an embodiment of the present disclosure.

FIG. 3 illustrates a view from above of an example scanning station, according to an embodiment of the present disclosure.

FIG. 4 illustrates an alternative view of the scanning station of FIG. 3, according to an embodiment of the present disclosure.

FIG. 5 illustrates an example user interface for operating an automated laser marking station according to an embodiment of the present disclosure.

FIGS. 6-7 illustrate an additional views of the automated laser marking system, according to an embodiment of the present disclosure.

FIG. 8 depicts a flow diagram of a method 800 for marking a dental appliance, according to embodiments of the present disclosure.

FIG. 9 shows a schematic diagram of a structure of a computer system in a terminal device or a server suitable for implementing an embodiment of the present application.

### DETAILED DESCRIPTION

The present disclosure relates to an automated laser marking system for marking dental appliances. Dental appliances can include a number of different devices, such as aligners, splints, retainers, etc. In some instances, various governmental or regulatory agencies may require specific markings on dental appliances, and dental appliances may also include manufacturer or branding information as well. These markings may be applied to the dental appliance using a laser source, which can etch information into the polymeric dental appliance. A need exists for an automated and expandable laser marking system.

The present technology is significantly more versatile and scalable than previous marking systems, while requiring less space and fewer labor resources. According to embodiments of the present disclosure, dental appliances can be loaded onto a conveyor tray at a loading station, and then codes located on the dental appliance and the conveyor tray can be scanned and matched to one another, thus identifying which appliance is located on which conveyor tray. The conveyor trays can then be transported to any one of a number of laser marking stations, where the marking station can scan the code on the conveyor tray to identify which markings need to be applied to the corresponding dental appliance. Because of the matching of the codes on the dental appliance (or the dental model, in some instances) and the conveyor tray, the marking station only needs to scan the code on the conveyor tray. Such a system is scalable, allowing the addition of as many marking stations as desired without needing to adjust any other portions of the system or any of the underlying operational software.

The dental appliances disclosed herein may be made of a polymeric material, such as a thin thermoformable material. In some cases, the dental appliances are thermoformed around a dental model of a patient's teeth. The thickness of the polymeric material is not particularly limited but should be of sufficient thickness to thermoform around a dental model. Preferably, the polymeric material is less than 5 mm thick. More preferably, the thickness of the polymeric material may be from about 0.05 to about 5 mm thick.

Examples of thermoforming materials include but are not limited to polyethylene terephthalate (PET), polyethylene terephthalate glycol (PETG), thermoplastic polyurethane (TPU), polyvinyl chloride (PVC), and other biocompatible polymers with suitable elasticity and plasticity for thermoforming.

The polymeric material can include, for example, a multilayer polymeric material such as those described in U.S. Pat. Nos. 10,549,511; 10,870,263; 10,987,907; 11,325,358; 10,946,630; US Patent Publication No. 2022/0118747; PCT Application No. PCT/US 2020/065928; PCT Application No. PCT/US 2022/025306; and Provisional U.S. Patent Application No. 63/354,998; all of which are incorporated by reference in their entirety.

When the thermoforming material is exposed to heat, the material becomes more pliable, which allows the material to mold and take the shape of an imprint when adequate pressure is applied.

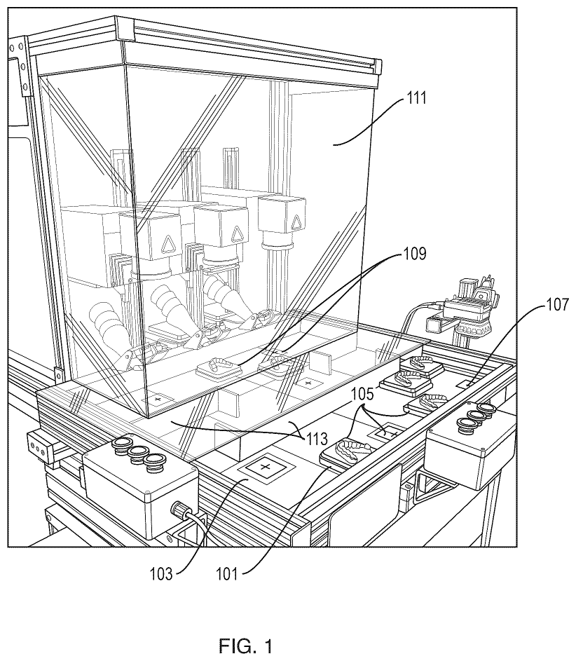

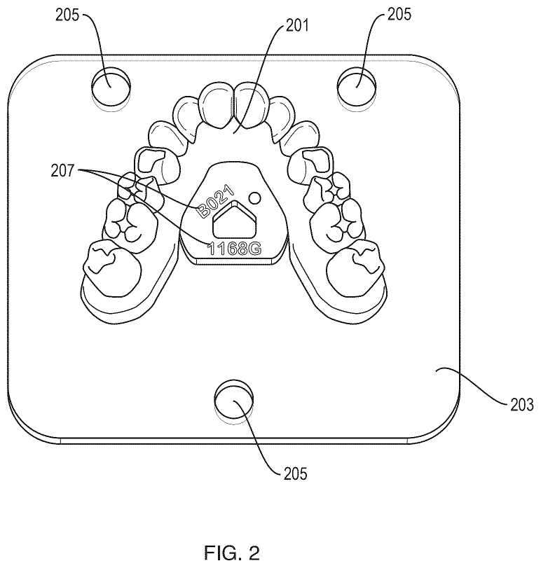

FIG. 1 shows an example automated laser marking system, according to an embodiment of the present disclosure. In this example, the laser marking system includes conveyor trays 101 that can hold a dental model and dental appliance (shown in more detail in reference to FIG. 2). Each conveyor tray is transported to different stations using a conveyor system. In one example embodiment, the conveyor system includes a magnetized table 103 that can interact with a magnetic portion of the conveyor tray to reposition the conveyor tray along the surface of the magnetized table to various positions and locations. An example magnetized system can include the Xplanar Conveyor System developed by Beckhoff Automation. Alternatively, a traditional conveyor belt or conveyor system can be used to transport the conveyor tray to the various stations discussed herein without the need to modify the underlying control software.

In one embodiment, the automated laser marking system includes a loading station 105, a scanning station 107, and one or more marking stations 109, among other components. In one example embodiment, the loading station is an area where the dental model and thermoformed material can be positioned onto a conveyor tray. The loading station can be organized to handle the loading of several parts at any given time. In the embodiment shown in FIG. 1, the loading station can accommodate the loading of three dental models at a time onto respective conveyor trays. In some embodiments, the dental models and thermoformed material can be positioned onto the conveyor tray using matching physical features on the tray and the aligner material and/or dental model. In one embodiment, during the thermoforming process a portion of the aligner material is thermoformed into grooves or cones shaped into a thermoforming base. These features can help the dental model and thermoformed material mate with the conveyor trays.

In one example embodiment, the conveyor tray includes a barcode, such as a 3-dimensional barcode, corresponding to the particular conveyor tray and identifying that tray from the other trays within the marking system and within the production line. The dental model also includes one or more codes incorporated into the model. In some cases, the code can include a part number that is an alphanumeric code printed into the model as raised or cutout lettering. This code can be printed into a tab portion that is positioned within the concave portion of the dental arch, in some embodiments. An example of such a code is shown as element 207 in FIG. 2. One skilled in the art will appreciate that various different types of computer readable or camera readable codes can be used for the code on the conveyor tray and the code on the dental model.

Once a dental model and the thermoformed material are positioned onto the conveyor tray at the loading station, the conveyor tray can be transported to a scanning station. In one embodiment, the scanning station includes one or more code readers, such as a barcode reader and a camera, which can read the barcode on the conveyor tray and the part code on the dental model discussed above. These code readers can then associate the part code, which corresponds to the particular dental appliance being manufactured, with the conveyor tray code, which corresponds to the particular tray in the production line. A computing system can then generate a table or database that associates the particular part code with the particular tray. In other words, the scanning station can read the part code associated with the dental appliance and marry it to the conveyor tray code. In some embodiments, there are two computing systems implemented, with one located at the scan station that makes the checks on the part and makes the correlation between the conveyor tray and the part, and another located at the laser marker that includes custom software that uses the second barcode scanner. In such an embodiment, the second computing system at the laser marker can use the second barcode scanner and ping the first computing system to get the appropriate information to be marked.

Once the scanning station has read the code on the dental model as well as the code on the conveyor tray, the conveyor tray can be transported to a marking station. In some embodiments, a number of laser marking stations can be implemented in order to expand or scale the capacity of the system. Each laser marking station can include a code reader that is capable of reading the barcode or computer readable code on a conveyor tray, and a laser source capable of emitting a laser to mark the thermoformed aligner. In some embodiments, the marking station also includes a vacuum that can clear the marking area of any vapor or gas resulting from the laser marking process. Because the scanning station has read the codes on the dental model and the conveyor tray and associated the code of the conveyor tray with the particular part number connected to the dental appliance, the laser marking station only needs to read the barcode on the conveyor tray in order to know what markings need to be made on the dental appliance. This provides a significant technical advantage by allowing the marking station to only require one code reader, and enabling the system to be expandable to any desired number of marking stations. In the embodiment shown in FIG. 1, the system includes three marking stations. However, the system could be expanded to many more marking stations, as long as the code on the conveyor tray has been matched with the code associated with the individual dental appliance.

While the primary embodiments discussed in this application involve laser marking on a thermoformed aligner, one skilled in the art will recognize that the systems and processes described herein could also be implemented with other marking systems (such as printed marking systems), and with other production systems (such as additive manufacturing or 3D printing processes, rather than thermoforming processes).

In some embodiments, when the marking stations are laser marking stations, a tinted laser shielding pane 111 and opaque barriers 113 can be used to protect operators from the laser light emitted from the laser sources. The design and orientation of the particular barriers shown in FIG. 1 allows the system to be used without any moving gates or doors, thus speeding up processing times. Because the barriers prevent any laser light from exiting the marking stations, other than through the laser-shielding pane 111, no moving gates or doors are needed to protect operators. In some alternative embodiments, the marking station can include other types of marking devices other than a laser source, such as a printer.

After the dental appliance has been marked at the marking station, it can be transported to an unloading station, or to exit the marking system. In some embodiments, the unloading station can be the same as the loading station. In alternative embodiments, the marked dental appliance and dental model can be transported by the conveyor tray to another processing station, such as a cutting or trimming station, a quality control station, etc.

FIG. 2 illustrates an example 3D printed dental model 201 with transparent aligner material 203 thermoformed over it, according to an embodiment of the present disclosure. FIG. 2 also shows alphanumerical lettering 207 that may be presented in various locations on the locator tab portion of the 3D printed dental model 201. This lettering can be in the form of raised or cutout lettering, and can be presented at different locations on the locator tab around the pentagon cutout. The alphanumerical lettering can be used to identify and match to a specific 3D model. For example, the camera at a scanning station can scan the locator tab, read the lettering, and match a dental model based on the lettering. In some embodiments, the dental model and the conveyor tray may include features disclosed in U.S. Provisional Patent Applications 63/428,923 and 63/428,967; each of which are incorporated by reference herein in their entirety.

In the particular embodiment shown in FIG. 2, the thermoforming process was used to form three cones 205 in the thermoformed material, that mate with concave cones or indentations in the conveyor tray. This technique can be used to secure the dental model and thermoformed material onto the conveyor tray during the laser marking process as the tray travels between the various stations discussed herein. One skilled in the art will appreciate that various different geometries can be used for this mating technique. In alternative embodiments, a feature or cutout portion of the dental model can be used to mate with a feature of the conveyor tray.

In an example, the alphanumerical lettering represents a case number and/or a step/arch identifier, which may be in the form of an encrypted code. In some embodiments, rather than being raised lettering, the lettering may be cut through the entire model to allow for more accurate reading from an optical character recognition camera. In a preferred embodiment, the length of the raised text is at least 1 mm, which overcomes potential issues in 3D printing. In an alternative embodiment, the lettering is entirely cut through the thickness of the locator tab. Having cutout lettering can further reduce the amount of material required during the 3D printing process.

As discussed above, the thermoforming process may generate a number of thermoformed cones 205, or other physical features, which can pair with features on the conveyor trays in order to secure the transparent aligner material 203 and the dental model 201 onto the conveyor trays.

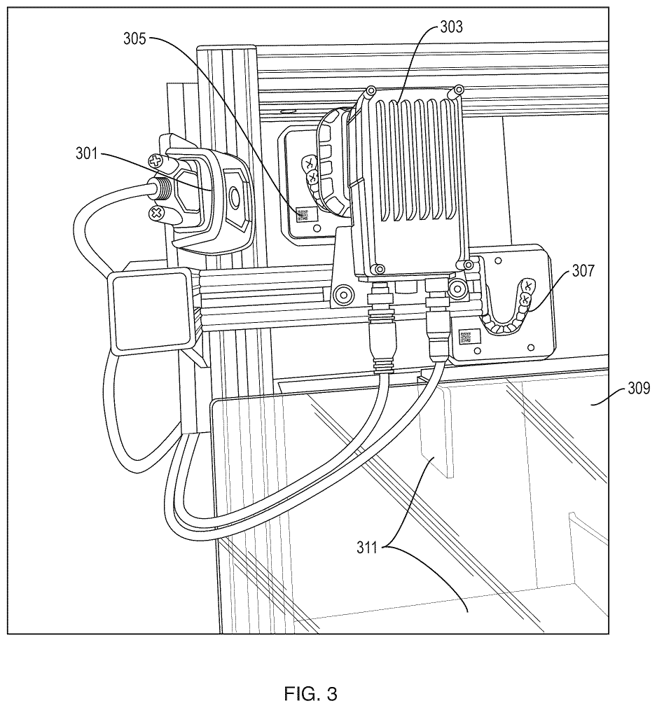

FIG. 3 illustrates a view from above of an example scanning station, according to an embodiment of the present disclosure. In this embodiment, the scanning station includes two code readers, namely a barcode reader 301 and a camera 303. In some embodiments, the camera 303 can read any alphanumeric lettering 207 that is located on the dental model, as discussed in reference to FIG. 2; while the barcode reader 301 can read a barcode 305 located on the conveyor tray. The barcode 305 can be a two-dimensional barcode, such as a data matrix code, in some embodiments, and can identify the particular conveyor tray. Once the alphanumeric lettering (e.g., a part code) associated with the aligner part and the barcode associated with the conveyor tray have been scanned or read, this information can be transmitted to a computing system so that the part code can be associated with the conveyor tray code. A computing system can generate a table or database that associates the particular part code with the particular tray. In the example shown in FIG. 3, one can see an additional conveyor tray with a second dental model 307 located in a staging area before it can move to the scanning station. FIG. 3 also illustrates how a protective transparent shield 309 and a number of opaque laser barriers 311 define the entrance of the laser marking area.

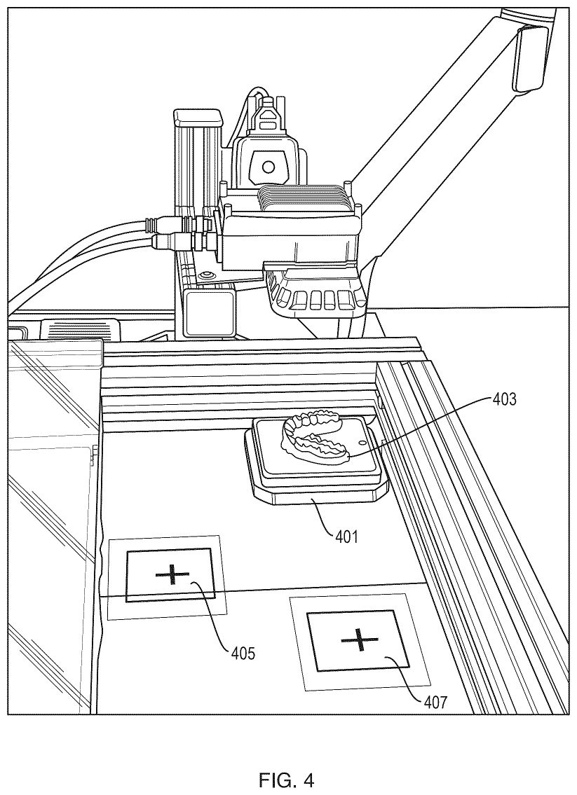

FIG. 4 illustrates an alternative view of the scanning station of FIG. 3, according to an embodiment of the present disclosure. In this view, one can clearly see the conveyor tray 401 with the dental model 403 that has aligner material thermoformed over it. The staging area 405 is vacant in this view, as well as one of the loading areas 407.

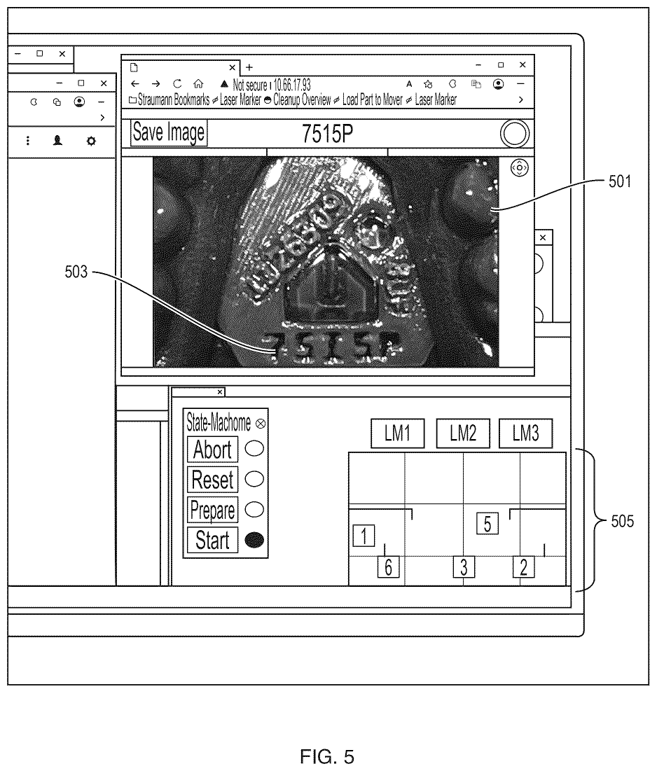

FIG. 5 illustrates an example user interface for operating an automated laser marking station according to an embodiment of the present disclosure. In this embodiment, a computing system can present an image 501 that has been captured by the camera 303 at the scanning station, showing the alphanumeric code 503 located on a portion of the dental model. The computing device can also display a visual representation 505 of the laser marking system, including representations of the locations of the various conveyor trays within the system. One skilled in the art will appreciate that the user interface can provide more or fewer types of information. For example, the user interface can provide information regarding the throughput of the laser marking system, the energy levels of the lasers, information regarding what types of markings are being made on the aligner material, whether any errors or delays exist within the system, etc.

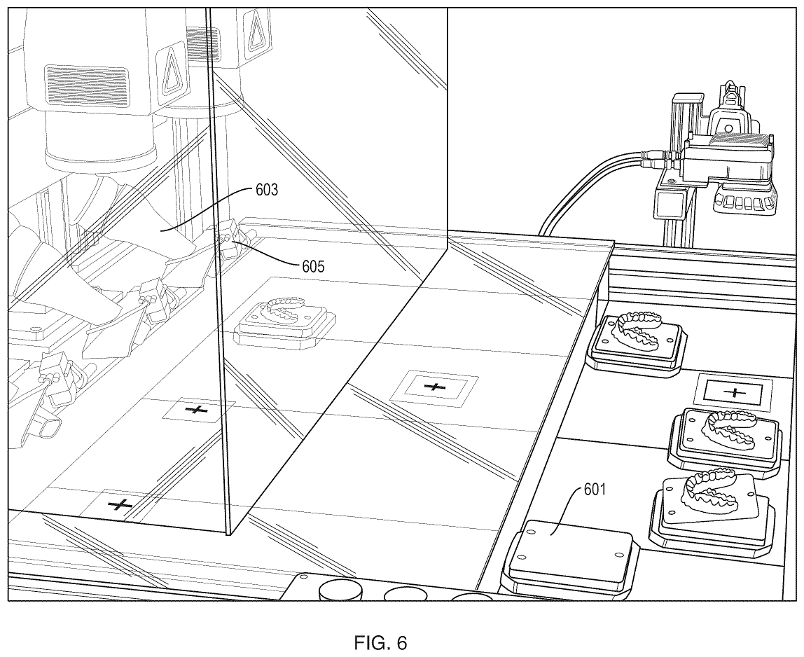

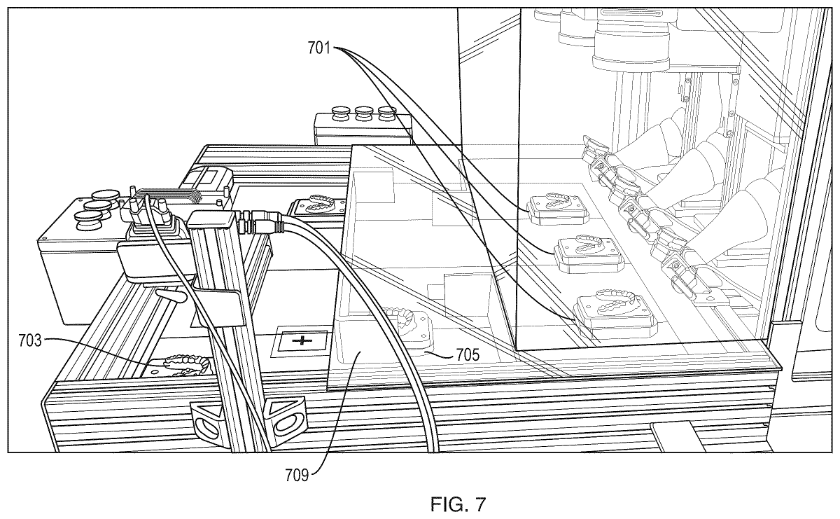

FIGS. 6-7 illustrate an additional views of the automated laser marking system, according to an embodiment of the present disclosure. In the example embodiment shown in FIG. 6, a conveyor tray 601 is shown that does not include any dental model or thermoformed material. This shows an example of what the conveyor tray might look like before a dental model is loaded onto it at a loading station, including a number of indentations designed to mate with thermoformed features (e.g., the thermoformed cones 205 shown in FIG. 2). In some embodiments, each marking station may include a fume extractor 603, which may be a vacuum designed to suck up and expel any fumes or debris generated during the laser marking process. Each marking station also includes a barcode reader and laser source 605, which may be included in any suitable housing or module. The laser source used in this machine is a 10 Watt Vereo™ UV Integration laser manufactured by Tykma Electrox, with a laser wavelength of 355 nm. In some embodiments, the laser source and barcode reader can be located next to one another or as a single module, and may be located alongside the fume extractor 603. The barcode reader at the laser marking station can be, for example, the same type of barcode reader as the one used at the scan station discussed above.

In the example embodiment shown in FIG. 7, the laser marking system is actively marking three dental appliances 701 at three marking stations. As discussed above, the system can be expanded to include any number of marking stations. FIG. 7 also illustrates one dental appliance 703 that is being scanned at the scanning station, and another dental appliance 705 that is making its way to a staging area near the marking stations around the barriers 709. According to one embodiment, once one of the appliances has been fully marked at one of the marking stations and proceeds to the unloading station, the next dental appliance will proceed to the available marking station. In some embodiments, the loading station and unloading station can be the same stations, or near one another.

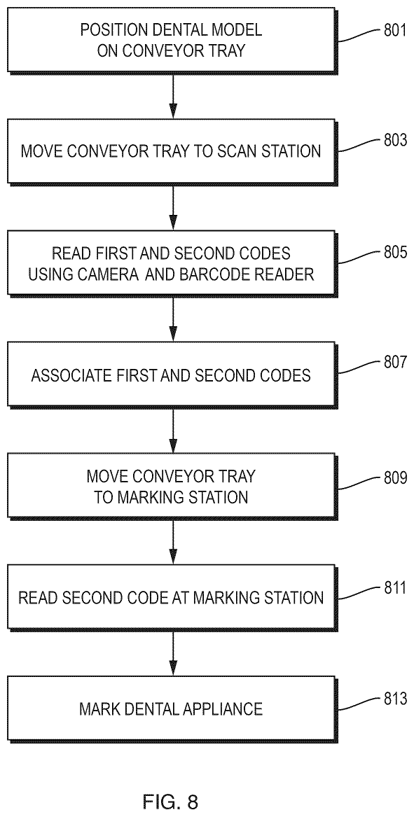

FIG. 8 depicts a flow diagram of a method 800 for marking a dental appliance, according to embodiments of the present disclosure. Although specific function blocks are disclosed in method 800, such blocks are examples, and one skilled in the art will appreciate that additional or fewer steps may be implemented in various embodiments, and the order of the function blocks may also be adjusted within the scope of the invention, unless specified otherwise. As such, the blocks in method 800 may be performed in an order different than presented, and not all of the blocks in method 800 may be performed.

At block 801, the dental model and dental appliance are positioned on the conveyor tray, As discussed above, in some embodiments, the dental appliance can include a number of thermoformed features (e.g., the thermoformed cones 205 shown in FIG. 2), which can mate with portions of the conveyor tray. The dental appliance can be, for example, a dental aligner or splint thermoformed over the dental model, The dental model can include a first code corresponding to a part number associated with the dental appliance, and the conveyor tray can include a second code specific to the conveyor tray. In some embodiments, the first code is a serial number printed into a portion of the dental model during a 3D printing process, as discussed above. This code can be either in raised or cutout lettering, in some embodiments. The dental appliance may be positioned on the conveyor tray at one of a number of loading stations.

At block 803, the conveyor tray is moved to the scanning station, which may include a camera for reading the first code and a barcode reader for reading the second code. As discussed above, the conveyor tray can be moved to the scanning station using a magnetized table conveyor system, or a traditional conveyor belt system, in various embodiments. One skilled in the art will appreciate that the present invention can be implemented with various different types of conveyor systems. In some embodiments, the barcode reader can read various different types of barcodes, such as two-dimensional and three-dimensional barcodes. Before moving the conveyor tray to the scanning station, the conveyor system can move the conveyor tray to one or more staging areas located between the loading station and the scanning station. This may be done, for example, in order to allow for the scanning of one or more parts that are ahead in a queue.

At block 805, the first and second codes are read using the camera and barcode reader at the scanning station. In some embodiments, the camera at the scanning station can read the first code incorporated into the dental model to identify the part number associated with the dental appliance thermoformed over the dental model. As discussed above, the first code can include alphanumeric lettering incorporated into the dental model during the 3D printing process. In some embodiments, the barcode reader at the scanning station can read the second code that is located on the conveyor tray in order to identify the conveyor tray.

At block 807, the first code corresponding to the part number is associated with the second code corresponding to the conveyor tray. By associating the part number code with the conveyor tray code, the conveyor tray can be sent to any one of a number of different marking stations, and each marking station only needs to read the second code that is located on the conveyor tray in order to mark the dental appliance with the appropriate markings. This provides a significant technical advantage by allowing each marking station to only require one code reader, and enabling the system as a whole to be scalable to any desired number of marking stations. In some embodiments, associating the first code and the second code can include generating a database that can include data reflecting which part numbers are associated with which conveyor trays at any given moment.

At block 809, once the first code and second code have been associated with one another, the conveyor tray moves to one of the marking stations, which each include a laser source and a barcode reader. As discussed above, the conveyor tray can be moved between the scanning station and the marking stations using any suitable type of conveyor system. One or more staging areas may also exist between the scanning station and the marking stations in order to facilitate the flow of conveyor trays through the system. In some embodiments, the marking station is shielded using opaque barriers and transparent laser shielding panes, such that the conveyor tray can pass around the opaque barriers without the need for any gate or door movements to protect users from laser light. This reduces the number of moving parts required by the system, and allows for quicker transportation of the conveyor trays from the scanning station to the appropriate marking station.

At block 811, the barcode reader at the laser marking station reads the second code to identify the part number based on the association between the first code and the second code. In some embodiments, this block includes querying a database formed during block 807 in order to retrieve the proper information to be marked on the dental appliance.

At block 813, the dental appliance is marked using the laser source at the marking station. In some embodiments, the laser source can include a UV laser, which can blend in well with a user's teeth, making the markings less noticeable. The laser marking system can be used to mark a part or product number on the dental appliance, a company name or logo, or any other suitable designs or symbols. In some instances, various governmental or regulatory agencies may require specific markings on dental appliances. In some embodiments, the marking station also includes a fume extractor, which may be a vacuum designed to suck up and expel any fumes or debris generated during the laser marking process. In some instances, the marking station can also mark a code on the excess aligner material that does not make up part of the dental appliance; and this code can be used in the trimming process before the aligner and model are removed from one another, but after the aligner and model are removed from the conveyor tray.

As discussed above, the techniques described herein allow for multiple dental appliances to be marked at the same time. This allows a single system to operate multiple marking stations at the same time. In one example, the automated laser marking system disclosed reduced labor needs at a laser marking station by 62% (from 21 operators down to 8), which could result in large financial savings, as well as a 75% reduction in floorspace required to complete the marking process.

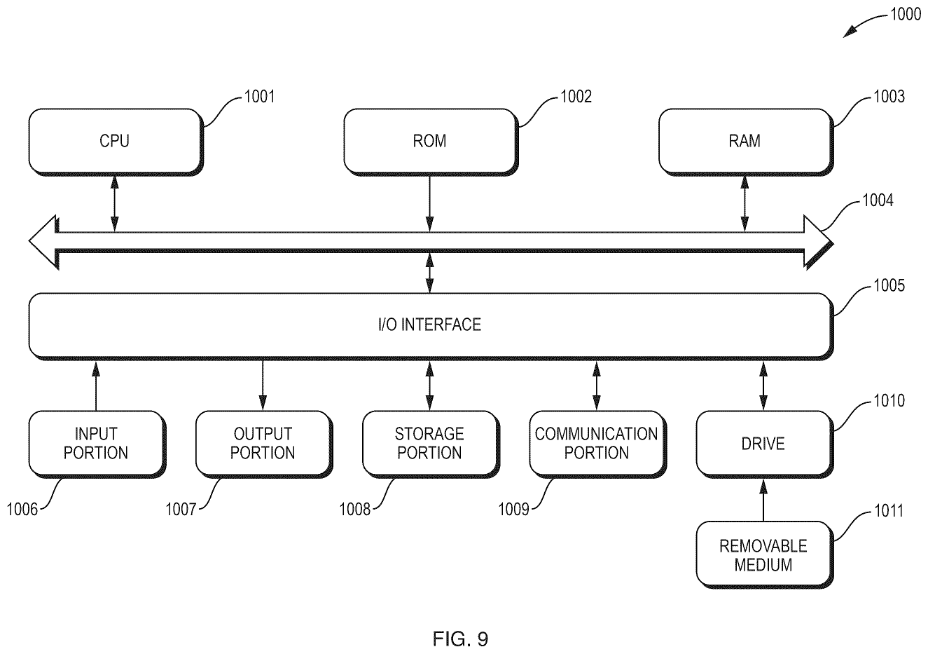

Referring to FIG. 9, a schematic structural diagram of a computer system 900 adapted to implement a server of the embodiments of the present application is shown. The computing system described below may be designed to implement the methods disclosed herein.

As shown in FIG. 9, a computer system 900 may include a central processing unit (CPU) 901, which may execute various actions and processes in response to the execution of a program stored in a read-only memory (ROM) 902 or a program loaded into a random access memory (RAM) 903 from a storage portion 908. The RAM 903 also may store various programs and data required by operations of the system 900. The CPU 901, ROM 902 and RAM 903 may be connected to each other through a bus 904, in some embodiments. An input/output (I/O) interface 905 (e.g., a touch screen, keyboard, mouse, microphone with voice recognition capabilities, etc.) can also be connected to the bus 904. The bus 904 may include one or more buses connected to each other through various bridges, controllers and/or adapters as is well known in the art.

In some embodiments, the input portion 906 (e.g., keyboard, touchscreen, mouse, etc.), output portion 907 (e.g., speaker, screen, etc.), storage portion 908 (e.g., hard disk, flash drive, etc.), and communication portion 909 (e.g., network interface card, etc.) are all connected to the I/O interface 905. The communication portion 909 can perform communication processes via a network, such as the Internet. A drive 910 can also be connected to the I/O interface 905 as needed. A removable medium 911, such as a magnetic disk, an optical disk, a magneto-optical disk, a flash drive, etc., may be placed on the drive 910, to enable the retrieval of a computer program from the removable medium 911, and the installation thereof on the storage portion 908 as needed.

According to one embodiment of the present disclosure, the process described above with reference to FIG. 8 may be implemented in a computer software program. For example, an embodiment of the present disclosure includes a computer program product, which comprises a computer program that is tangibly embedded in a machine-readable medium. The computer program comprises program codes for executing the method of FIG. 8. In such an embodiment, the computer program may be downloaded and installed from a network via the communication portion 909, and/or may be installed from the removable media 911, It will be appreciated that the present invention may utilize a nonvolatile memory which is remote from the system, such as a network storage device which is coupled to the data processing system through a network interface such as a modem, an Ethernet interface or a wireless network.

Portions of what was described above may be implemented with logic circuitry such as a dedicated logic circuit or with a microcontroller or other form of processing core that executes program code instructions. Thus, processes taught by the discussion above may be performed with program code such as machine-executable instructions that cause a machine that executes these instructions to perform certain functions. In this context, a “machine” may be a machine that converts intermediate form (or “abstract”) instructions into processor specific instructions (e.g., an abstract execution environment such as a “virtual machine” (e.g., a Java Virtual Machine), an interpreter, a Common Language Runtime, a high-level language virtual machine, etc.), and/or, electronic circuitry disposed on a semiconductor chip (e.g., “logic circuitry” implemented with transistors) designed to execute instructions such as a general-purpose processor and/or a special-purpose processor. Processes taught by the discussion above may also be performed by (in the alternative to a machine or in combination with a machine) electronic circuitry designed to perform the processes (or a portion thereof) without the execution of program code.

The present invention also relates to an apparatus for performing the operations described herein. This apparatus may be specially constructed for the required purpose, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), RAMs, EPROMs, EEPROMs, magnetic or optical cards, or any type of media suitable for storing electronic instructions, and each coupled to a computer system bus.

A machine readable medium includes any mechanism for storing or transmitting information in a form readable by a machine (e.g., a computer). For example, a machine readable medium includes read only memory (“ROM”); random access memory (“RAM”); magnetic disk storage media; optical storage media; flash memory devices; etc.

An article of manufacture may be used to store program code. An article of manufacture that stores program code may be embodied as, but is not limited to, one or more memories (e.g., one or more flash memories, random access memories (static, dynamic or other)), optical disks, CD-ROMs, DVD ROMs, EPROMs, EEPROMs, magnetic or optical cards or other type of machine-readable media suitable for storing electronic instructions. Program code may also be downloaded from a remote computer (e.g., a server) to a requesting computer (e.g., a client) by way of data signals embodied in a propagation medium (e.g., via a communication link (e.g., a network connection)).

The foregoing is only a description of the preferred embodiments of the present application and the applied technical principles. It should be appreciated by those skilled in the art that the inventive scope of the present application is not limited to the technical solutions formed by the particular combinations of the above technical features, The inventive scope should also cover other technical solutions formed by any combinations of the above technical features or equivalent features thereof without departing from the concept of the invention, such as, technical solutions formed by replacing the features as disclosed in the present application with (but not limited to), technical features with similar functions,

1. A method of marking a dental appliance, comprising:
positioning a dental model and a dental appliance on a conveyor tray, the dental model including a first code corresponding to a part number associated with the dental appliance, and the conveyor tray including a second code specific to the conveyor tray;
moving the conveyor tray to a scan station, the scan station including a camera for reading the first code and a first barcode reader for reading the second code, reading the first code using the camera associated with a computing system to identify the part number associated with the dental appliance;
reading the second code using the first barcode reader to identify the conveyor tray;
associating the first code corresponding to the part number with the second code corresponding to the conveyor tray;
moving the conveyor tray to a marking station, the marking station including a laser source and a second barcode reader;
reading the second code using the second barcode reader to identify the part number based on the association between the first code and the second code;
marking the dental appliance using the laser source.

2. The method of claim 1, wherein the dental appliance is a transparent aligner thermoformed over the dental model.

3. The method of claim 1, wherein associating the first code with the second code allows the conveyor tray to be sent to any one of the plurality of laser marking stations.

4. The method of claim 3, wherein moving the conveyor tray to the marking station includes moving the conveyor tray to any one of the plurality of laser marking stations.

5. The method of claim 1, wherein the marking station is shielded using one or more opaque barriers and one or more transparent laser shielding panes.

6. The method of claim 1, wherein the dental appliance is positioned on the conveyor tray at a loading station.

7. The method of any claim 1, wherein moving the conveyor tray includes transporting the conveyor tray along a linear conveyor system or conveyor belt.

8. The method of claim 1, wherein moving the conveyor tray includes transporting the conveyor tray in two dimensions over a surface of a magnetized table conveyor system.

9. The method of claim 1, wherein the first code is a serial number printed into a portion of the dental model during a 3D printing process.

10. The method of claim 1, wherein the first barcode reader and the second barcode reader can read a two-dimensional barcode or a three-dimensional barcode.

11. A system for marking an orthodontic aligner, comprising:
a loading station including a conveyor tray for holding a dental model and a dental appliance, the dental model including a first code corresponding to a part number associated with the dental appliance, and the conveyor tray including a second code specific to the conveyor tray;
a scan station including a camera for reading the first code, and a first barcode reader for reading the second code;
a marking station including a laser source and a second barcode reader;
a computing system in communication with the camera, the first barcode reader, the second barcode reader, and the laser source, the computing system configured to:
associate the first code corresponding to the part number with the second code corresponding to the conveyor tray;
identify the part number at the marking station using information obtained from the second barcode reader; and
instruct the laser source to mark the dental appliance with the appropriate marking; and
a conveyor system for moving the conveyor tray between the loading station, the scan station, and the marking station.

12. The system of claim 11, wherein the marking station further includes a fume extractor to expel any fumes or debris generated during the laser marking process.

13. The system of claim 11, wherein the dental appliance is a transparent aligner thermoformed over the dental model.

14. The system of claim 11, wherein associating the first code with the second code allows the conveyor tray to be sent to any one of the plurality of laser marking stations.

15. The system of claim 14, wherein moving the conveyor tray to the marking station includes moving the conveyor tray to any one of the plurality of laser marking stations.

16. The system of claim 11, further comprising one or more opaque barriers and one or more transparent laser shielding panes for shielding the marking station.

17. The system of claim 11, wherein the conveyor system includes a linear conveyor system or conveyor belt.

18. The system of claim 11, wherein the conveyor system includes a magnetized table conveyor system.

19. The system of claim 11, wherein the first barcode reader and the second barcode reader can read a two-dimensional barcode or a three-dimensional barcode.

20. An automated laser marking system, comprising:
a loading station for loading a plurality of conveyor trays each with a 3D printed dental model and a dental appliance, the dental model including a first code corresponding to a part number associated with the dental appliance, and the conveyor tray including a second code specific to the conveyor tray, wherein the dental appliance is thermoformed over the dental model;
a scan station including a camera for reading the first code, and a first barcode reader for reading the second code;
a plurality of marking stations, each marking station including a laser source, a second barcode reader, and a fume extractor,
a conveyor system for moving each of the plurality of conveyor trays between the loading station, the scan station, and one of the plurality of marking stations; and
a computing system in communication with the camera, the first barcode reader, the second barcode reader, and the laser source, the computing system configured to:
associate the first code corresponding to the part number with the second code corresponding to the conveyor tray for each of the plurality of conveyor trays at the scan station;
for each conveyor tray located at each of the plurality of marking stations, identify the part number at the marking station using information obtained from the second barcode reader; and
for each of the plurality of marking stations, instruct the laser source to mark the dental appliance with the appropriate marking.
